(19) United States
(12) Patent Application Publication
(10) Pub. No.: US 2017/0078748 A1
(43) Pub. Date: Mar. 16, 2017

(54) FORECASTING AND GUIDANCE OF CONTENT CONSUMPTION

(71) Applicant: THOMSON LICENSING, Issy de Moulineaux (FR)

(72) Inventors: Azin Ashkan, San Jose, CA (US); Brian Eriksson, San Jose, CA (US); Jean C. Bolot, Los Altos, CA (US); William Trouleau, Gex (FR)

(21) Appl. No.: 14/850,233

(22) Filed: Sep. 10, 2015

(51) Int. Cl. H04N 21/466; H04N 21/45; H04N 21/258; H04N 21/25

(52) U.S. Cl. CPC H04N 21/4667; H04N 21/251; H04N 21/4532; H04N 21/25891

(57) ABSTRACT

Ways to generate optimized content offers for extended viewing sessions are described. A usage analyzer (140) collects and analyzes information before the start of content consumption within a session. As a user accesses content via a user device (130) and/or content server (120), session information including context attributes, content attributes, and user attributes are collected and analyzed. In addition, viewing session information from previous viewing sessions (and/or sessions associated with other users) is analyzed. Consumption behavior is extracted (430) and used to predict (440) whether the user will be serial watching multiple content items. If the user is predicted as an offer candidate, an offer may be sent (450) to the user device to increase the velocity of content consumption within the viewing session.

### BACKGROUND

Many consumers receive media content via one or more streaming services. Such services allow on-demand viewing of several content items (e.g., a set of sequential episodes of a TV show). Binge-watching has become increasingly popular as consumers discover new shows and watch several episodes in a row during a single viewing session.

Content providers would find it useful to be able to predict a binge-watching session based on previous watching sessions associated with the user (and/or other users).

Thus there is a need for ways to analyze session data, identify situations where a user may prefer to watch multiple associated content items, and generate an offer related to the multiple associated content items.

### SUMMARY

Some embodiments may forecast whether a user will view a set of associated content items in a current or future session (e.g., by finishing an entire season of a particular television show). Analysis of single session and/or prior viewing behavior may be used to enhance the accuracy of predicting future content consumption. Use information may be extracted from the start of a user session and from prior watching behavior.

Ways to predict extended viewing sessions are described. A usage analyzer (140) collects and analyzes information before the start of content consumption within a session. As a user accesses content via a user device (130) and/or content server (120), session information including context attributes, content attributes, and user attributes are collected and analyzed. In addition, viewing session information from previous viewing sessions (and/or sessions associated with other users) is analyzed. Consumption behavior is extracted (430) and used to predict (440) whether the user will be serial watching multiple content items during the current session. If the user is predicted as an offer candidate, an offer may be sent (450) to the user device to increase the velocity of content consumption within the viewing session.

Various inventive features are described below that can each be used independently of one another or in combination with other features. Broadly, some embodiments generally provide ways to collect and analyze data associated with content consumption during distinct viewing sessions. Such consumption may be related to multiple associated content items (e.g., episodes of a season) and the viewing sessions may include any content consumption where no breaks in consumption (e.g., stopping or pausing playback) exceed a threshold value. Some embodiments may generate offers based on the consumption data. Such offers may include discounted access to the associated content items and/or an access expiration time. In addition to consumption data, other data may be collected and analyzed. For instance, information such as search history of a user, content ratings, etc.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a hardware system according to an exemplary embodiment;

FIG. 2 illustrates a schematic block diagram of an exemplary usage analysis device of some embodiments;

FIG. 3 illustrates a flow chart of an exemplary process that identifies and stores session data in some embodiments;

FIG. 4 illustrates a flow chart of an exemplary process used by some embodiments to generate offers related to associated content items;

FIG. 5 illustrates a flow chart of an exemplary process that analyzes session viewing data;

FIG. 6 illustrates a flow chart of an exemplary process 600 that analyzes the session viewing data before a first instance of content consumption; and

FIG. 7 illustrates a schematic block diagram of an exemplary computer system that implements some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

By identifying situations where a user is more likely to consume multiple related content items, content providers may be able to improve the user experience in various ways. For instance, if a user purchases a few episodes of a television show (and/or otherwise associated content items), the upcoming episodes may be offered to the user based on a calculated probability that the user will finish the entire season in a current or future session.

User-specific actions may include targeting users that are more likely to finish a television series with expiring offers in order to increase the speed of content consumption.

A viewing session may include all content views of a user with less than a specified time break threshold between interactions. Such a threshold may be set to a particular value based on various relevant factors (e.g., session data associated with the current user, default value, etc.). Session durations may vary based on the threshold time. A typical session related to a television series may last about one hour.

If a user accesses a video on-demand service and chooses a content item to view, some embodiments may extract features related to the viewing session that reveal more information about the content consumption behavior of the user. For example, multiple categories of influence on viewing behavior may be utilized, including content, context, and user.

As a user accesses content to begin a session, various attributes of the content may be determined. For instance, some embodiments may identify the genre of the content (e.g., action, comedy, drama, etc.), the average length of a content item (e.g., an episode), the number of associated items in a set (e.g., the number of episodes in a season), and viewing patterns of the general community for a specified collection of content.

In addition, various context attributes associated with a session may be determined. For instance, timing information such as the day of the week and the time the user starts the session may be collected. As another example, the remaining number of unwatched episodes in a season may be determined or the number of days the content has been available on the content service may be retrieved.

User information may also be collected and/or analyzed. Such information may include, for instance, whether the user has watched multiple associated content items in a session before, whether the previous session of the user included viewing of multiple associated content items, the elapsed time since the user accessed the content provider, etc.

Some embodiments may predict which users are likely to consume multiple related content items using a machine learning classifier that is trained on features of television content, session context, and user habits extracted from the very start of each user session.

Machine learning techniques utilized by some embodiments may include, for instance, latent Dirichlet allocation (LDA), nearest neighbor, decision trees, adaptive boosting (adaboost), random forests, logistic regression, etc.

Many users may exhibit consistent behavior when accessing a video on demand (VOD) or other content provision service. Such behavior may be used to predict future content consumption.

Several more detailed embodiments are described in the sections below. Section I provides a description of an exemplary system architecture. Section II then describes exemplary methods of operation. Lastly, Section III describes an exemplary computer system.

### I. System Architecture

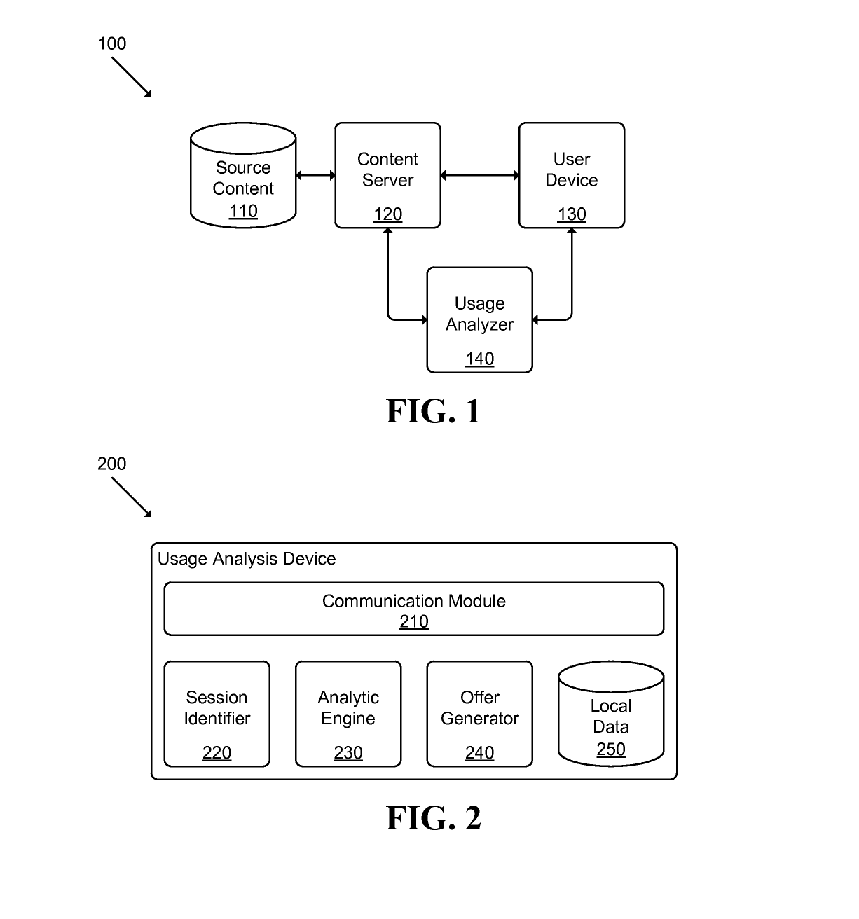

FIG. 1 illustrates a schematic block diagram of a hardware system 100 according to an exemplary embodiment. As shown, the system may include a source content storage 110, a content server 120, a user device 130, and a usage analyzer 140.

Each source content storage 110 may be a device capable of storing media content. The system 100 may include multiple source content storages 110 that may be associated in various different ways (e.g., multiple storages may be associated with a single content provider, multiple content providers may each provide sets of storages, etc.). The storage may be accessible across various networks or communication pathways. In some embodiments, the storage may be accessed via an application programming interface (API) and/or other appropriate resources.

The source content may include content items associated with, for example, TV shows, clips, movies, web series, podcasts, music videos, etc. Source content may be associated based on various relevant factors. For instance, episodes from a series may be generally linked together as a set and individual episodes may be linked to other episodes in an ordered playlist. Other examples of associated source content include movies (e.g., grouped by director, genre, cast, etc.), audio tracks from an album, sports highlights (e.g., grouped by sport, by region, by team, etc.), web clips or other content provided in a shared playlist, etc. The source content may be linked automatically based on the above factors and/or based on selections received from a user (e.g., by selecting a sub-set of episodes or movies from among a presented list or grouping).

The content server 120 may be a computing device that is able to retrieve content from the source content storage 110 and provide the retrieved content to various user devices 130.

Each user device 130 may be an electronic device capable of providing content to a user. Such devices may include, for instance, personal computers, tablets, smartphones, laptops, TVs, gaming consoles, etc.

The usage analyzer 140 may be a computing device that is able to interact with the content server 120, user device 130, and/or other system elements. The usage analyzer 140 may be able to analyze session data to extract relevant information that may be used to generate offers related to associated content items. In some embodiments, the usage analyzer 140 may provide data that is able to be utilized by the content server 120.

Although the system 100 has been described by reference to various exemplary details, one of ordinary skill in the art will recognize that the system may be implemented in various other ways without departing from the scope of the disclosure. For instance, some embodiments may include additional elements or omit some elements. As another example, the elements may be arranged in different specific ways with different communication pathways. In addition, some embodiments may include multiple instances of each type of element (e.g., multiple analytic resources associated with multiple external platforms, multiple user devices associated with multiple different users, etc.).

FIG. 2 illustrates a schematic block diagram of an exemplary usage analysis device 200 of some embodiments. The usage analysis device 200 may be implemented by a device such as usage analyzer 140, content server 120, user device 130, and/or combinations of similar elements. As shown, the usage analysis device 200 may include a communication module 210, a session identifier 220, an analytic engine 230, an offer generator 240, and local data 250.

The communication module 210 may allow the processing device 200 to communicate across one or more networks or interfaces in order to communicate with other system elements (e.g., content storages, user devices, analytic resources, etc.).

The session identifier 220 may be able to evaluate viewing of content items and group associated items into a session. For instance, a user may view several sequential episodes of a TV show in one session. Such sessions may be defined based on a minimum break threshold. Such a break threshold may define a maximum duration of time between active viewing of content items by a user before a session is ended. Such a break in viewing may be associated with various user actions (e.g., pausing or stopping playback, powering off a viewing device, etc.). In addition, such a break may be associated with user inaction (e.g., failure to select a next content item in a series, failure to respond to a query, etc.).

The analytic engine 230 may retrieve data from various sources (e.g., content servers, user devices, etc.) and perform analysis to determine behaviors associated with viewing of multiple associated content items. Such analysis may be based on content items viewed within a single session, content items viewed by other users, etc. Such behavior determination may be used by the offer generator 240 to identify potential sets of associated content that may appeal to a user.

The offer generator 240 may identify a set of associated content items to include in an offer based on some appropriate criteria. For instance, the offer generator 240 may identify multiple episodes of a TV show, may identify multiple different shows related to a particular entertainer, etc. The offer generator may generate a listing of content items and a playback order.

Local data 250 may include data structures and data stored at the processing device 200. Such data may include content, session data, user data, analytic data, etc.

While device 200 has been described by reference to various exemplary details, one of ordinary skill in the art will recognize that the device may be implemented in various other ways without departing from the scope of the disclosure. For instance, some embodiments may include additional elements or omit some elements.

### II. Methods of Operation

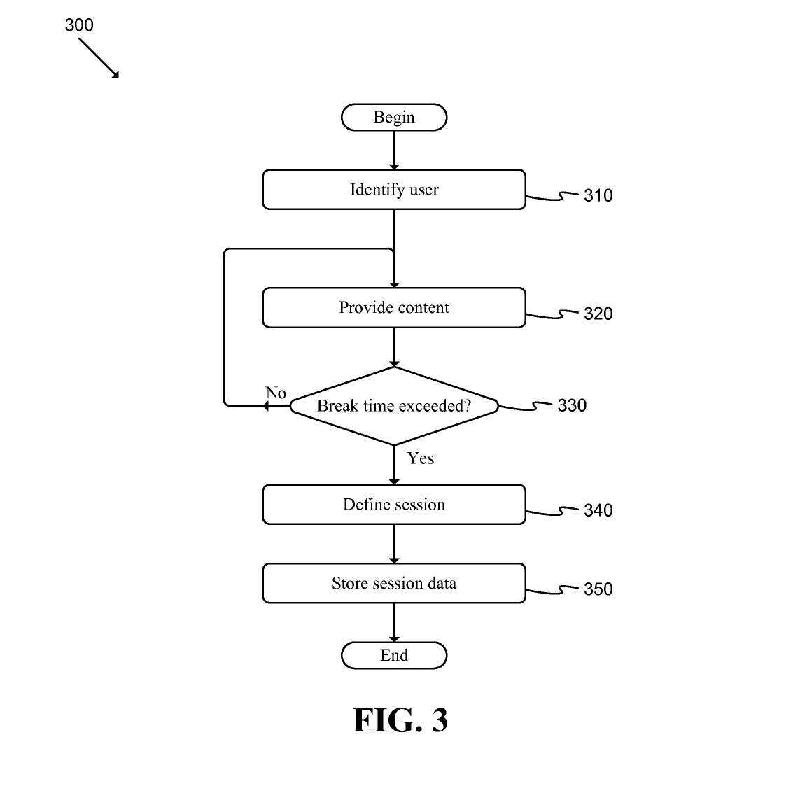

FIG. 3 illustrates a flow chart of an exemplary process 300 that identifies and stores session data in some embodiments. The process may be executed by an element such as content server 120, user device 130, and/or usage analyzer 140. The process 300 may begin, for instance, when a user selects content for viewing, when a user accesses a content service, etc.

As shown, the process may identify (at 310) a user. The user may be identified in various appropriate ways. For instance, the user may have a username and/or password associated with a particular content provider (and/or other account). In addition to identifying a user, any interactions of the user with the system from the beginning of the session until and including a first selection of content for playback during that session may be identified.

Next, the process may provide (at 320) content to the user. The content may be provided based on various appropriate criteria (e.g., user selection, user attributes, default selection, etc.). In some cases, an initial content selection may be used to identify various attributes that may be used to generate and provide offers to a user. Such attributes may include the identity of the content item, a list of associated content items (e.g., episodes in a season), mean length of the associated items, number of items in the set, genre of the content item, etc.

The process may then determine (at 330) whether a threshold time has been exceeded. Such a threshold time may be associated with a stoppage of viewing. Such a stoppage may be induced by a user (e.g., by selecting a “stop playback” button) or may be inferred based on user behavior (e.g., lack of affirmation to continue to a next item in a list). If the process determines (at 330) that the threshold time has not been exceeded, the process may repeat operations 310-330.

If the process determines (at 0330) that the break threshold time has been exceeded, the process may then define (at 340) session data associated with the viewing session, store (at 350) the data, and then may end.

Such session data may include, for instance, content data (e.g., listing of content items, type of content, genre of content, average length of content items, number of items in a set, etc.), context data (e.g., view timing information such as day of week and time of day that the session started and/or ended, remaining number of items in an associated set of items such as a TV season, number of days the content has been available, etc.), and/or user data (e.g., whether the user has previously watched multiple associated content items in a single session, whether the previous viewing session of the user included multiple associated content items, how many days have passed since the user last accessed the system, etc.).

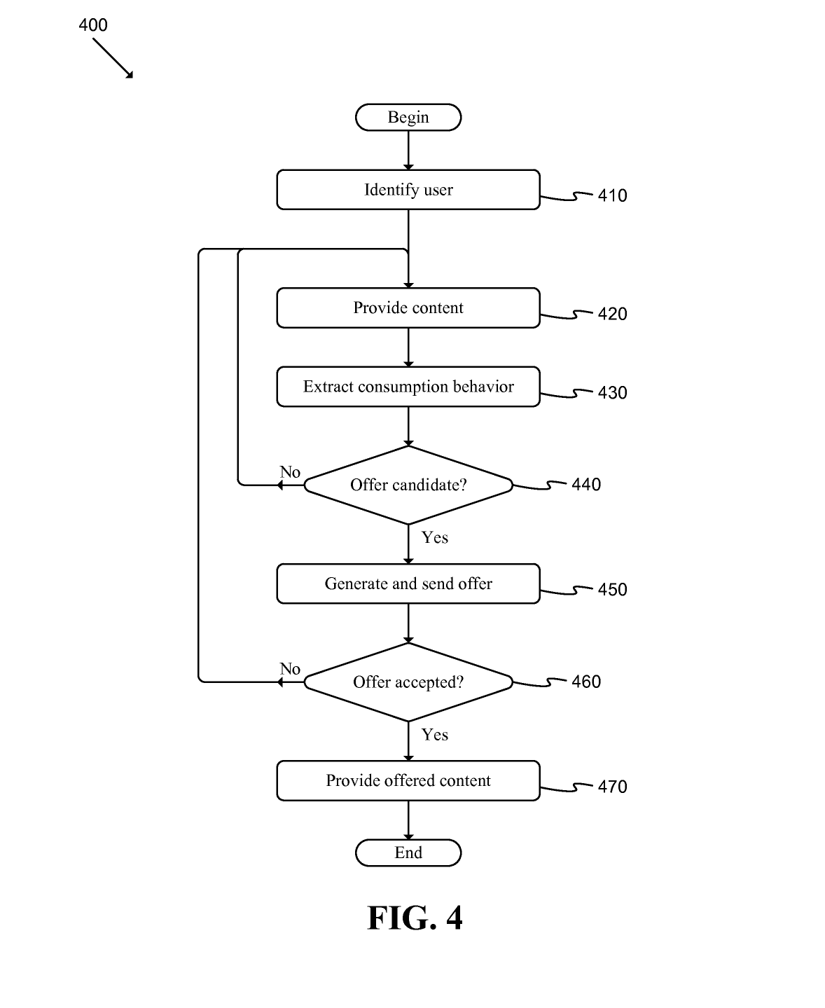

FIG. 4 illustrates a flow chart of an exemplary process 400 used by some embodiments to generate offers related to associated content items. The process 400 may be executed by an element such as content server 120, user device 130, usage analyzer 140 (and/or a combination of such elements).

As shown, the process may identify (at 410) a user. The user may be identified in various appropriate ways. For instance, the user may have a username and/or password associated with a particular content provider (and/or other account).

Next, the process may provide (at 420) content to the user. The content may be provided based on various appropriate criteria (e.g., user selection, user attributes, default selection, etc.).

The process may then extract (at 430) information related to consumption behavior. Such consumption behavior may include, for instance, content attributes, context attributes, and/or user attributes.

Next, the process may determine (at 440) whether the user is an offer candidate. If the process determines that the user is not an offer candidate, the process may repeat operations 420-440. If the process determines (at 440) that the user is an offer candidate, the process may generate and send (at 450) the offer to the user.

The offer may be at least partly based on analysis of the extracted consumption behavior information. For instance, the process may determine the likelihood that a user will continue watching a series of related content items (e.g., a sequential set of TV shows from a particular broadcast season). Such a determination may be made based on various relevant criteria.

As one example, previous viewing habits of the user (e.g., maximum length of previous session, previous multi-item sessions associated with the current content item, average or latest end time of a session, etc.) may be used as a set of factors in a probabilistic determination as to whether the user may desire additional associated content items during the current session. As another example, the offer may be based on relevant viewing habits of similar users.

In some embodiments, the offer may be at least partly based on popularity of the set of content items (among similar users or users in general) and/or other attributes of the content (e.g., genre, episode length, number of episodes in a set or season, etc.).

Some embodiments may base the offer at least partly on context of the session. For instance, time of the session (e.g., start time, day of the week, etc.), remaining number of episodes in a set, number of days the content has been available, etc. may be used to generate an appropriate offer.

In some embodiments, the offer may include an expiration (e.g., the last several items in a set may be made available to be viewed until an expiration time for a specified price). Such a feature may increase the consumption velocity associated with each user.

Next, the process may determine (at 460) whether the offer has been accepted. Such a determination may be made based on various relevant factors. For instance, some embodiments may determine whether an acceptance message has been received. As another example, some embodiments may automatically provide the offered content unless a rejection is received. In this way, a user session may be automatically extended until the user affirmatively stops playback or takes some other appropriate action.

If the process determines (at 460) that the offer has not been accepted, the process may repeat operations 420-460 until the session ends or the process determines (at 460) that the offer has been accepted. If the process determines that the offer has been accepted, the process may provide (at 470) the offered content and then may end.

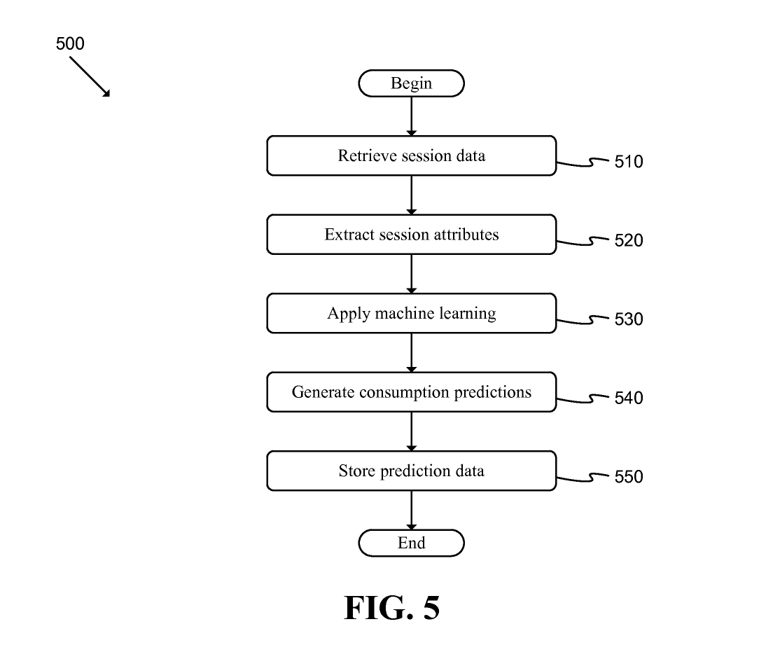

FIG. 5 illustrates a flow chart of an exemplary process 500 that analyzes session viewing data. Such a process may be executed by a device such as usage analyzer 140. The process may begin, for instance, when a user launches a content player or service. Alternatively, the process may be executed offline using previously collected session information.

As shown, the process 500 may retrieve (at 510) session data. Such data may be related to a current session (or sessions) and/or previous sessions. The session data may be associated with a current user, a group of users, a content provider, etc.

Next, the process may extract (at 520) various sessions attributes. Such attributes may include content, context, and/or user attributes, as appropriate.

The process may then apply (at 530) machine learning to the extracted attributes. Such machine learning may include probabilistic modeling using LDA, nearest neighbor, decision tree, and/or other appropriate algorithms. Such algorithms may be enhanced using meta algorithms such as adaboost. Random forests may be used for ensemble learning to correct for over-fitting. Some embodiments may utilize logistic regression to optimize prediction of a binary dependent variable (e.g., whether a user will accept an offer or not).

Process 500 may be used in real time to determine content, context, and user information associated with a viewing session. Some embodiments may determine a likely length of the viewing session. User habits may be predicted based on data points related to content, context, and user information from past viewing sessions. Related content may be identified and offered at a discount for a limited period of time based on the predicted user habits.

Next, the process may generate (at 540) consumption predictions. Such prediction may be related to content the particular user is likely to view during a session, content likely to be viewed based on sessions associated with other users, etc.

The process may then store (at 550) and/or provide the prediction data. Such data may be provided as parameters to be utilized by others (e.g., content providers) and/or may be provided as a list of content items to be provided to a user (and/or the content may be provided directly to the user or content provider).

In some embodiments, interaction data and/or attributes may be gathered at the start of a session up to the user's first viewing within a session so that real-time targeted offers may be provided based on a content providers offer budget, for example.

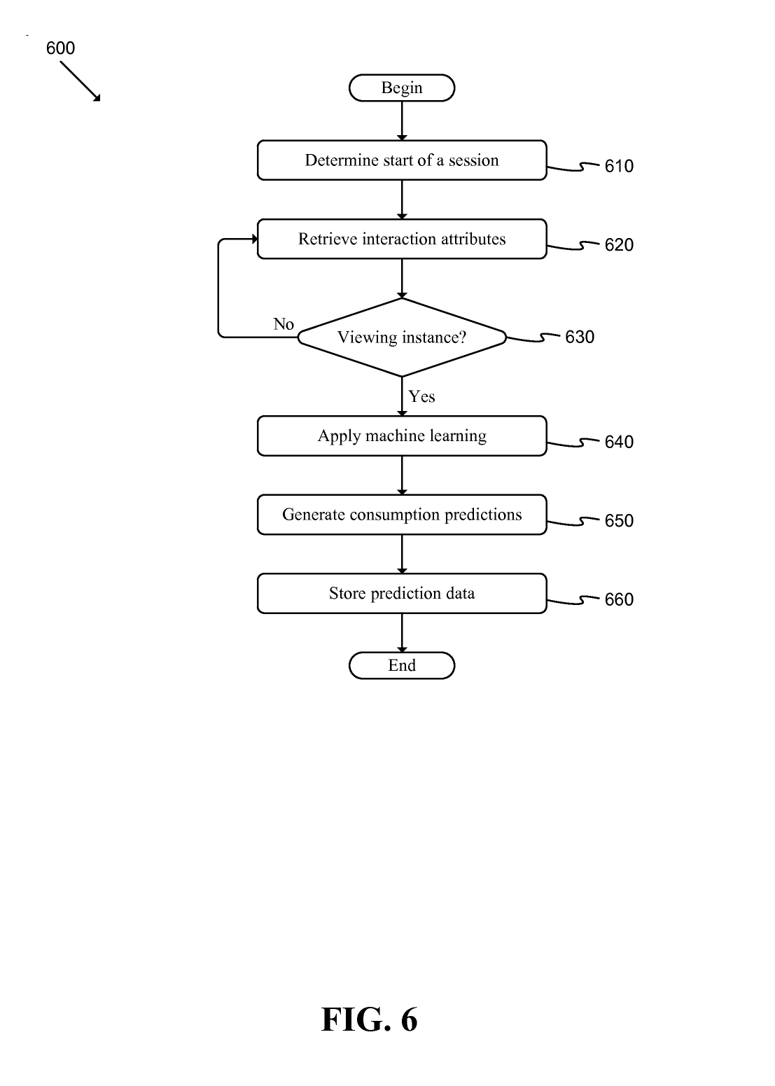

FIG. 6 illustrates a flow chart of an exemplary process 600 that analyzes the session viewing data before a first instance of content consumption. Such a process may be executed by a device such as usage analyzer 140. The process may begin, for instance, when a user launches a content player or service.

As shown, the process 600 may determine (at 610) the start of a viewing session. Next, interaction attributes may be retrieved (at 620) in real time. The process 600 may continue to retrieve interaction attributes before a user begins his or her first content viewing instance by checking (at 630) whether a viewing instance has begun (e.g., playback of an episode).

The collected interaction data may fall in the one of the three previously discussed groups of content dependent, user dependent, or context dependent data. For example, content dependent data may include the number of episodes for a particular television program the user is browsing, the number of days since the last episode was released in the browsed series, etc. User dependent data may include whether the user has consumed serial watching (i.e. binge watching) before in their history of interactions with the system, whether the user had binge watched in their last session, demographics, etc. Context dependent information may include the time of day, day of the week, season of the year, etc.

The process 600 may then apply (at 640) machine learning to the extracted attributes. Such machine learning may include probabilistic modeling using LDA, nearest neighbor, decision tree, and/or other appropriate algorithms. Such algorithms may be enhanced using meta algorithms such as adaboost. Random forests may be used for ensemble learning to correct for over-fitting. Some embodiments may utilize logistic regression to optimize prediction of a binary dependent variable (e.g., whether a user will accept an offer or not).

Based on the on the above interaction data that is retrieved at the start of a viewing session and before a first watching instance, the process may then generate (at 650) consumption predictions, which, in this case, includes the likelihood that the viewing session will be a binge session where the user will serially consume multiple related content items in that single viewing session. By answering these questions, the content provider may be able target users in real-time during a current viewing session more effectively.

One instance where real time targeting may be advantageous, for example, may be when there is a limited budget to put a few episodes of a TV show together (i.e., in a bundle) with a discounted price. For instance, when two users are currently watching the same episode of a particular TV show, and a limited budget does not allow both users to be targeted with the discount at the same time. In such a case, the likelihood of the session of the first user turning into a binge-watching session may be predicted to be higher than the likelihood of that of the second user. Based on such a determination before the user begins a first viewing instance, it may be better to target the first user with the bundle discount offer in their current session over the second user.

The process may then store (at 660) and/or provide the prediction data. Such data may be provided as parameters to be utilized by others (e.g., content providers) and/or may be provided as a list of content items and/or bundle offers to be provided to a user. For example, if it is determined that targeting the first user with the bundle discount offer has a higher probability of actual purchase, then as the user is watching their first episode in the current session he or she may be presented a small pop-up beside the screen offering them the bundle discount on the next three episodes of the show at some point during the episode (e.g., beginning, middle, end of episode playback).

One of ordinary skill in the art will recognize that processes 300-600 are exemplary in nature and may be implemented in various different ways without departing from the scope of the disclosure. For instance, the operations may be performed in different orders, different operations may be included, and/or some operations may be omitted. In addition, the processes (and/or portions thereof) may be performed concurrently, sequentially, iteratively, at regular intervals, and/or based on some specified criteria. Furthermore, each process may be performed as a part of a macro-process and/or be divided into multiple sub-processes.

In addition, processes 300-600 may be implemented by various combinations of system components. For instance, a server may provide content to a user device for playback to a user. The user may enter content selections on a user device and the user device may send a request to a server for the selected content. A user device and/or server may interact with a usage analyzer to determine whether to generate a content offer.

### III. Computer System

Many of the processes and modules described above may be implemented as software processes that are specified as one or more sets of instructions recorded on a non-transitory tangible storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

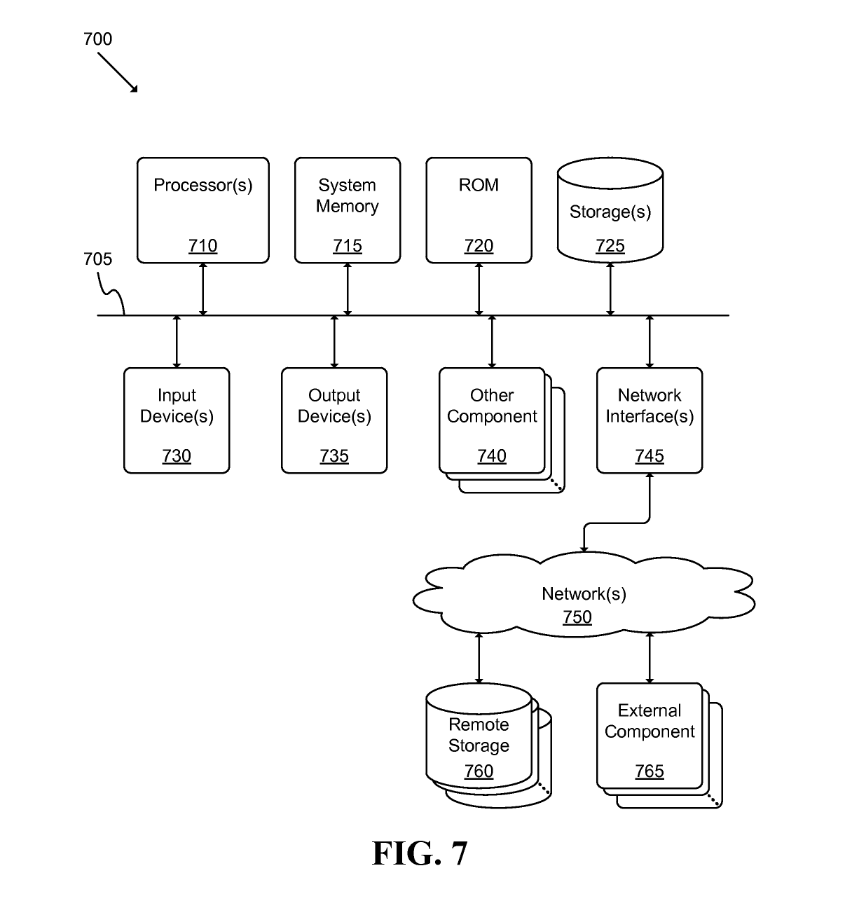

FIG. 7 illustrates a schematic block diagram of an exemplary computer system 700 used to implement some embodiments. For example, the system described above in reference to FIGS. 1-2 may be at least partially implemented using computer system 700. As another example, the processes described in reference to FIGS. 3-6 may be at least partially implemented using sets of instructions that are executed using computer system 700.

Computer system 700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, various other components 740 (e.g., a graphics processing unit), and one or more network interfaces 745.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wired or wireless connection protocol or system.

The one or more processors 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, and/or audio devices. Some or all of the input and/or output devices may be wirelessly or optically connected to the computer system.

Other components 740 may perform various other functions. These functions may include performing specific functions (e.g., graphics processing, sound processing, etc.), providing storage, interfacing with external systems or components, etc.

Finally, as shown in FIG. 7, computer system 700 may be coupled to one or more networks 750 through one or more network interfaces 745. For example, computer system 700 may be coupled to a web server on the Internet such that a web browser executing on computer system 700 may interact with the web server as a user interacts with an interface that operates in the web browser. Computer system 700 may be able to access one or more remote storages 760 and one or more external components 765 through the network interface 745 and network 750. The network interface(s) 745 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that provides content to a user, the method comprising:
determining a start of a viewing session;
retrieving interaction attributes of the viewing session, wherein the interaction attributes include interaction data up until the start of a viewing instance, and wherein the interaction data comprises 1) content dependent data including a number of episodes for a particular television program that the user is browsing, 2) user dependent data including whether the user has serially watched a television series in a previous session, and 3) content dependent information including time of the viewing session; and
predicting, based on the retrieved interaction attributes, the likelihood the user will consume multiple related content items during the viewing session.

2. The method of claim 1 further comprising determining a previous serial watching sessions by the user.

3. (canceled)

4. The method of claim 1 further comprising providing real time offers based on the predicting.

5. The method of claim 1, wherein context dependent data further comprise at least one of a number of unwatched items from the set of associated content items, and a duration that the set of associated content items has been available.

6. The method of claim 1, wherein content dependent data further comprise at least one of an initial content selection, a genre of the initial content selection, a list of associated content items, a mean length of the associated content items, and a number of items in the list.

7. The method of claim 1, wherein user dependent data further comprise at least one of the identity of the user, and time passed since a previous viewing session.

8. An apparatus that provides content to a user, comprising:
a processor for executing a set of instructions; and
a non-transitory medium that stores the set of instructions, wherein the set of instructions comprises:
determining a start of a viewing session;
retrieving interaction attributes of the viewing session, wherein the interaction attributes include interaction data up until the start of a viewing instance, and wherein the interaction data comprising 1) content dependent data including a number of episodes for a particular television program that the user is browsing, 2) user dependent data including whether the user has serially watched a television series in a previous session, and 3) content dependent information including time of the viewing session; and
predicting, based on the retrieved interaction attributes, the likelihood the user will consume multiple related content items during the viewing session.

9. The apparatus of claim 8, wherein the set of instructions further comprises determining a previous serial watching sessions by the user.

10. (canceled)

11. The apparatus of claim 8 wherein the set of instructions further comprises providing real time offers based on the predicting.

12. The apparatus of claim 8, wherein context dependent data further comprise at least one of a number of unwatched items from the set of associated content items, and a duration that the set of associated content items has been available.

13. The apparatus of claim 8, wherein the apparatus is a user device.

14. The apparatus of claim 8, wherein the apparatus is a server.
